(19) United States
(12) Patent Application Publication
(10) Pub. No.: US 2024/0053546 A1
(43) Pub. Date: Feb. 15, 2024

(54) FERRULE, OPTICAL CONNECTOR, OPTICAL CONNECTOR MODULE AND MANUFACTURING METHOD FOR OPTICAL CONNECTOR

(71) Applicant: Enplas Corporation, Saitama (JP)

(72) Inventor: Ayano HINATA, Saitama (JP)

(21) Appl. No.: 18/446,536

(22) Filed: Aug. 9, 2023

(30) Foreign Application Priority Data
Aug. 12, 2022 (JP) 2022-129101

(51) Int. Cl. G02B 6/38; G02B 6/40

(52) U.S. Cl. CPC G02B 6/3834; G02B 6/403; G02B 6/3861

(57) ABSTRACT

A ferrule includes: an optical transmission member alignment part for aligning optical transmission members extending in the first direction in one line in the second direction; a first surface for incidence of light from the optical transmission members; a second surface for emitting outside light entering from the first surface; and an optical transmission member insertion part disposed opposite to the first surface with respect to the optical transmission member alignment part, and including a contact portion where the optical transmission members are touchable. When the opening side and the opposite side are set as plus and minus sides, respectively, with respect to the optical transmission member alignment part in the third direction, the contact portion is disposed to come closer to the minus side with increasing distance from the first surface.

This application is entitled to the benefit of Japanese Patent Application No. 2022-129101, filed on Aug. 12, 2022, the disclosure of which including the specification, drawings and abstract is incorporated herein by reference in its entirety.

### TECHNICAL FIELD

The present invention relates to a ferrule, an optical connector, an optical connector module and a manufacturing method for an optical connector.

### BACKGROUND ART

In the related art, a plurality of optical transmission members has been used for the purpose of increasing the capacity in the field of optical communications of transmitting light emitted from a light-emitting element such as a surface-emitting laser (for example, a vertical cavity surface emitting laser (VCSEL)). Further, optical connectors for optically coupling optical transmission members are known (see, for example, PTL 1).

PTL 1 discloses an optical connector including a plurality of optical fibers in a ribbon form and a ferrule holding the plurality of optical fibers. The cover is removed at the tip end portion of the plurality of optical fibers of the ribbon form, and the plurality of optical fibers are separated from each other. At the time of assembling the optical connector disclosed in PTL 1, the plurality of optical fibers is tilted and inserted from the back side of the ferrule, with the tip end portion facing downward. At this time, the ferrule is positioned at a predetermined position by sliding the plurality of optical fibers in such a manner that the tip end portion of the plurality of optical fibers is parallel to the installation surface while keeping the tilted state.

### CITATION LIST

### Patent Literature

PTL 1
Japanese Patent Application Laid-Open No. 2015-082078

### SUMMARY OF INVENTION

### Technical Problem

To achieve the optical fiber disclosed in PTL 1, it is necessary to perform a cleaving process after removing the cover at the tip end portion of the optical fiber of the ribbon form. At this time, the tip end portion of the optical fiber may possibly be bent. In the optical connector disclosed in PTL 1, the tip end portion of the plurality of optical fibers is positioned with the grounding surface of the ferrule and the tip end portion of the plurality of optical fibers in contact with each other, but the tip end of the optical fiber may possibly float from the installation surface. In this case, it is necessary to perform fine adjustment for each optical fiber, thus making the manufacture of the optical connector complicated.

An object of the present invention is to provide a ferrule that can be appropriately manufacture an optical connector regardless of the bending of the tip end of the optical fiber. In addition, another object of the present invention is to provide an optical connector and an optical connector module including the ferrule. Further, another object of the present invention is to provide a manufacturing method for the optical connector.

### Solution to Problem

[1] A ferrule configured to hold a plurality of optical transmission members each extending in a first direction, the ferrule including: an optical transmission member alignment part configured to align the plurality of optical transmission members in one line in a second direction orthogonal to the first direction; an opening disposed to face the optical transmission member alignment part; a first surface disposed to face end surfaces of the plurality of optical transmission members aligned by the optical transmission member part, the first surface being configured to allow incidence of light emitted from the plurality of optical transmission members or emit, to outside, light advanced inside the ferrule; a second surface configured to emit, to the outside, light entered from the first surface or allow incidence of light from the outside; and an optical transmission member insertion part disposed on a side opposite to the first surface with respect to the optical transmission member alignment part, and including a contact portion where the plurality of optical transmission members is touchable. When an opening side is set as a plus side and a side opposite to the opening side is set as a minus side with respect to the optical transmission member alignment part set as a reference in a third direction orthogonal to the first direction and the second direction, a portion closest to the reference in the contact portion is disposed on the minus side, and a portion other than the portion closest to the reference in the contact portion is disposed to come closer to the minus side with increasing distance from the first surface.
[2] The ferrule according to [1], further including a supporting part disposed to face the contact portion in the third direction and configured to support, from a side opposite to the contact portion, the plurality of optical transmission members inserted to the optical transmission member insertion part.
[3] In the ferrule according to [1] or [2], the contact portion includes an inclined surface disposed to come closer to the minus side with increasing distance from the first surface, or a plurality of step surfaces disposed to come closer to the minus side with increasing distance from the first surface.
[4] In the ferrule according to any one of [1] to [3], the first surface or the second surface includes a plurality of optical control surfaces, the number of the plurality of optical control surfaces being the same as the number of the plurality of optical transmission members.
[5] An optical connector including: a plurality of optical transmission members; the ferrule according to any one of [1] to [4] configured to hold the plurality of optical transmission members; and a lid configured to adjust positions of the end surfaces of the plurality of optical transmission members with respect to the first surface by pressing the plurality of optical transmission members aligned by the optical transmission member alignment part and being in contact with the optical transmission member insertion part with a pressing surface configured to make contact with the plurality of optical transmission members.
[6] In the optical connector according to any one of [1] to [5], the plurality of optical transmission members includes: a first portion where the plurality of optical transmission members is coupled and aligned in one line; and a second portion located on a tip end side than the first portion, the second portion being a portion where the plurality of optical transmission members is separated from each other.
[7] A manufacturing method for the optical connector according to [5], the method including: supporting the plurality of optical transmission members in a state where the plurality of optical transmission members is in contact with the contact portion and tilted; aligning the end surfaces of the plurality of optical transmission members by pressing the lid toward the plurality of optical transmission members, or moving the lid toward the first surface such that light emitted from the end surfaces of the plurality of optical transmission members is incident on the first surface, or that light emitted from the first surface is incident on the end surfaces of the plurality of optical transmission members; supplying an adhesive to the optical transmission member alignment part; and fixing the positions of the end surfaces of the plurality of optical transmission members aligned, by curing the adhesive.
[8] The method according to [5], further including: supporting the plurality of optical transmission members in a state where the plurality of optical transmission members is in contact with the contact portion and tilted such that the plurality of optical transmission members comes closer to the plus side in a direction from the optical transmission member insertion part toward the optical transmission member alignment part by inserting the plurality of optical transmission members from a back side opening of the optical transmission member insertion part; aligning the end surfaces of the plurality of optical transmission members by pressing the lid toward the plurality of optical transmission members or moving the lid toward the first surface such that light emitted from the end surfaces of the plurality of optical transmission members is incident on the first surface, or light emitted from the first surface is incident on the end surfaces of the plurality of optical transmission members; supplying adhesive to the optical transmission member alignment part; and fixing the positions of the end surfaces of the plurality of optical transmission members aligned, by curing the adhesive.
[9] A manufacturing method for an optical connector including the ferrule according to [4], and a lid configured to adjust positions of the end surfaces of the plurality of optical transmission members with respect to the first surface by pressing the plurality of optical transmission members aligned by the optical transmission member alignment part and being in contact with the optical transmission member insertion part with a pressing surface configured to make contact with the plurality of optical transmission members, the method including: supporting the plurality of optical transmission members in a state where the plurality of optical transmission members is in contact with the contact portion and separated from the optical transmission member alignment part such that the plurality of optical transmission members comes closer to the plus side in a direction from the optical transmission member insertion part toward the optical transmission member alignment part by inserting the plurality of optical transmission members from a back side opening of the optical transmission member insertion part; aligning the end surfaces of the plurality of optical transmission members by pressing the lid toward the plurality of optical transmission members or moving the lid toward the first surface such that a center of the end surfaces of the plurality of optical transmission members and a center of the optical control surface coincide with each other; supplying adhesive to the optical transmission member alignment part; and fixing the positions of the end surfaces of the plurality of optical transmission members aligned, by curing the adhesive.
[10] In the method according to any one of [7] to [9], the plurality of optical transmission members includes: a first portion where the plurality of optical transmission members is coupled and aligned in one line; and a second portion located on a tip end side than the first portion, the second portion being a portion where the plurality of optical transmission members is separated from each other; and in the supporting, the second portion is disposed at the optical transmission member alignment part, and the first portion is brought into contact with the contact portion.
[11] The method according to [10], further including moving the second portion from a contact portion side toward a supporting part side after the fixing of the positions of the end surfaces of the plurality of optical transmission members.
[12] An optical connector module including the optical connector according to [5] or [6].

### Advantageous Effects of Invention

According to the present invention, the position of the end portion of the optical transmission member can be easily adjusted in the ferrule.

### BRIEF DESCRIPTION OF DRAWINGS

FIG. 1 is a perspective view of an optical connector according to Embodiment 1 of the present invention;

FIGS. 2A to 2C are diagrams illustrating a configuration of the optical connector according to Embodiment 1;

FIGS. 3A and 3B are diagrams illustrating a configuration of the optical connector according to Embodiment 1;

FIG. 4 is a perspective view of a ferrule according to Embodiment 1;

FIGS. 5A to 5C are diagrams illustrating a configuration of the ferrule according to Embodiment 1;

FIGS. 6A and 6B are sectional views of the ferrule according to Embodiment 1;

FIGS. 7A to 7E are diagrams illustrating a configuration of a lid of Embodiment 1;

FIGS. 8A to 8D are diagrams for describing a manufacturing method for an optical connector;

FIG. 9 is a flowchart illustrating a manufacturing method for the optical connector according to Embodiment 1;

FIGS. 10A and 10B are diagrams illustrating a configuration of an optical connector according to Embodiment 2;

FIG. 11 is a perspective view of a ferrule according to Embodiment 2;

FIGS. 12A to 12C are diagrams illustrating a configuration of the ferrule according to Embodiment 2;

FIGS. 13A and 13B are sectional views of the ferrule according to Embodiment 2;

FIGS. 14A to 14C are diagrams illustrating a configuration of an optical connector according to Embodiment 3;

FIGS. 15A to 15E are diagrams illustrating a configuration of a lid of Embodiment 3;

FIGS. 16A and 16B are diagrams illustrating a configuration of an optical connector of Embodiment 4;

FIGS. 17A to 17C are diagrams illustrating a configuration of an optical connector according to Embodiment 5;

FIGS. 18A to 18C are diagrams illustrating a configuration of a ferrule according to Embodiment 5;

FIGS. 19A to 19D are diagrams illustrating a configuration of a lid of Embodiment 5;

FIGS. 20A and 20B are diagrams illustrating a configuration of an optical connector according to Embodiment 6;

FIG. 21 is a perspective view of a ferrule according to Embodiment 6,

FIGS. 22A to 22C are diagrams illustrating a configuration of the ferrule according to Embodiment 6; and

FIGS. 23A and 23B are sectional views of the ferrule according to Embodiment 6.

### DESCRIPTION OF EMBODIMENTS

A ferrule, an optical connector and an optical connector module according to embodiments of the present invention are elaborated below with reference to the accompanying drawings.

### Embodiment 1

### Configuration of Optical Connector

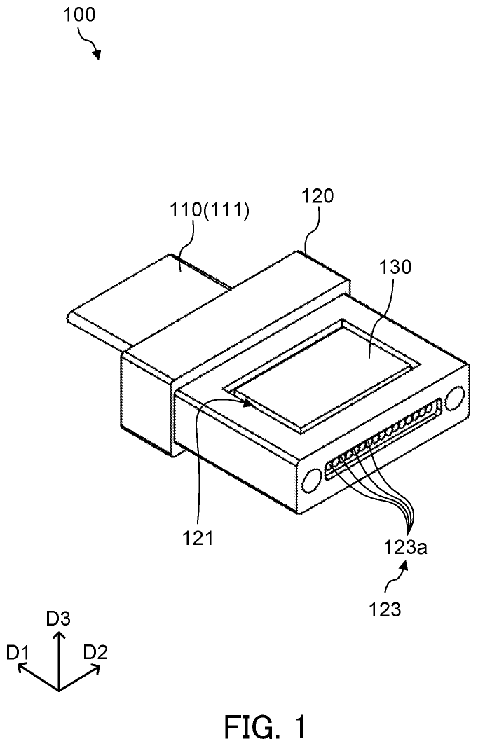

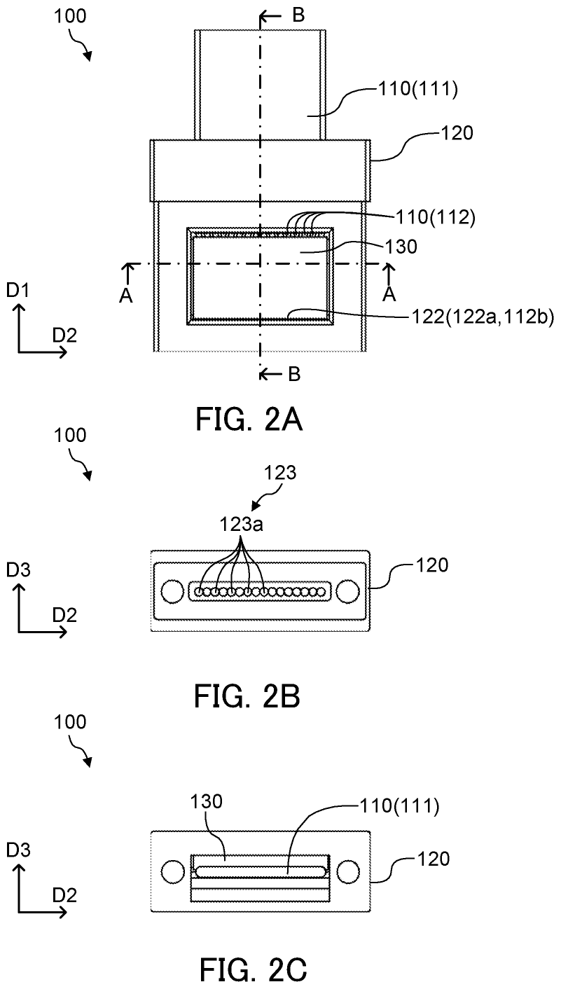

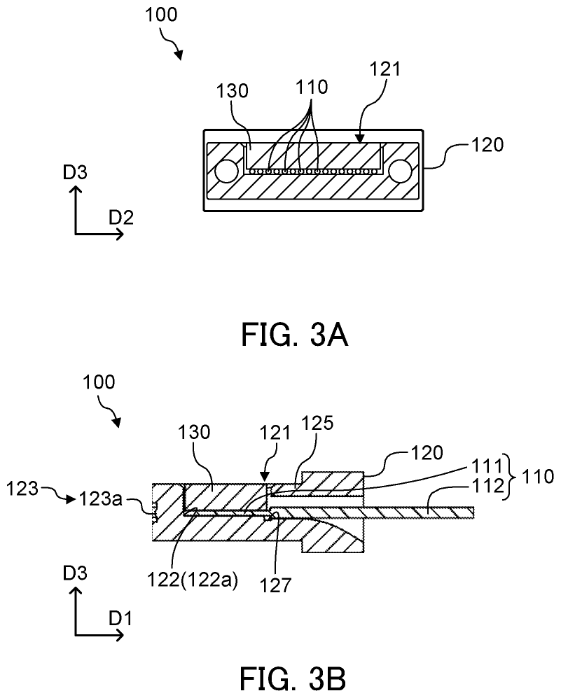

FIG. 1 is a perspective view of optical connector 100 according to Embodiment 1 of the present invention. FIG. 2A is a plan view of optical connector 100, FIG. 2B is a front view, and FIG. 2C is a back view. FIG. 3A is a sectional view taken along line A-A of FIG. 2A, and FIG. 3B is a sectional view taken along line B-B of FIG. 2A.

Note that in the following description, the extending direction of optical transmission member 110 is first direction D1, the direction in which optical transmission members 110 are arranged in a line (the direction in which second optical surfaces 123a are arranged) is second direction D2, and the direction orthogonal to first direction D1 and second direction D2 is third direction D3. In addition, in assembling optical connector 100, the side on which adhesive G is injected is the upper side (upper surface), and the side opposite to the upper side is the lower side (lower surface). Note that the upper side and the lower side do not mean the actual use direction, but are defined for description in the present embodiment.

As illustrated in FIGS. 1, 2A to 2C, 3A and 3B, optical connector 100 according to Embodiment 1 includes a plurality of optical transmission members 110, ferrule 120, and lid 130. Optical connector 100 according to the present embodiment can be used as an optical connector module together with a housing, a spring clamp structure part and the like (omitted in the drawing). In the present embodiment, two optical connectors 100 may be paired (as a pair) to optically connect optical transmission members 110, or optically connect a photonic integrated circuit and optical transmission member 110. In the present embodiment, the plurality of optical transmission members 110 are optically coupled with each other by connecting one optical connector 100 holding the plurality of optical transmission members 110 to another optical connector 100 holding other optical transmission members 110 with a connection pin not illustrated in the drawing.

The type of optical transmission member 110 is not limited. Examples of the type of optical transmission member 110 include optical fibers and light waveguides. In the present embodiment, optical transmission member 110 is an optical fiber. In addition, the optical fiber may be of a single mode type, or a multiple mode type. Preferably, the end surface of optical transmission member 110 is tilted with respect to a plane orthogonal to the extending direction of optical transmission member 110 (first direction D1). In the present embodiment, the inclination angle to the plane is 8°, for example. The number of optical transmission members 110 is not limited as long as a plurality of the optical transmission members is provided. In the present embodiment, the number of optical transmission members 110 is 16. Preferably, each of the plurality of optical transmission members 110 includes first portion 111 and second portion 112. First portion 111 is a portion in a ribbon form with the plurality of optical transmission members 110 coupled and aligned in one line. In first portion 111, adjacent two optical transmission members 110 may be partially coupled with each other, or they may be entirely coupled with one another. Second portion 112, located on the tip end side than first portion 111, is a portion where the cover is removed with the plurality of optical transmission members 110 separated from each other. The end surface of optical transmission member 110 is the tip end of second portion 112. The end portion of optical transmission member 110 is fixed to ferrule 120.

### Configuration of Ferrule

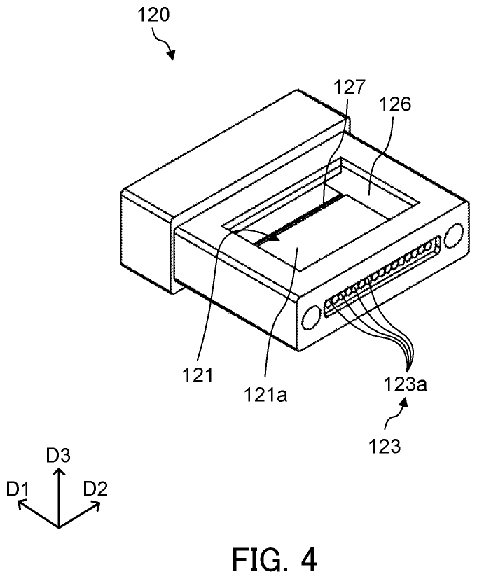

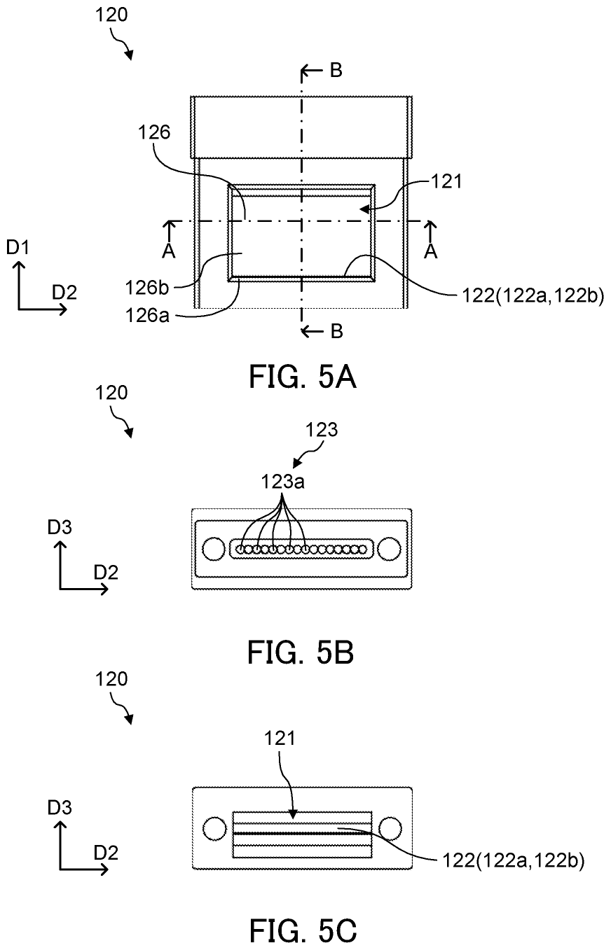

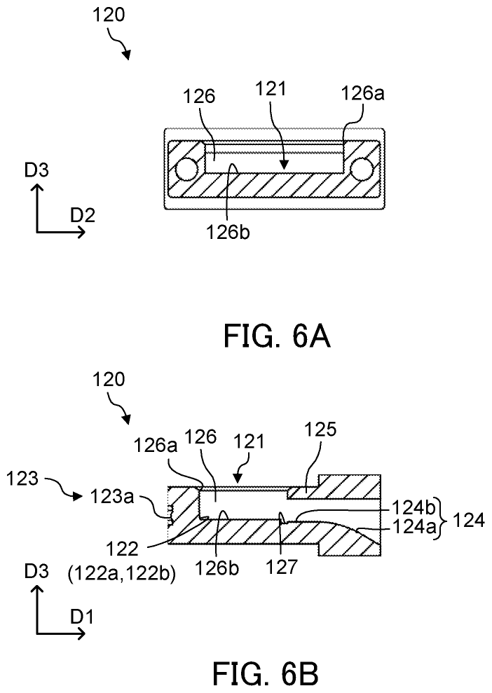

FIGS. 4, 5A to 5C, 6A and 6B are diagrams illustrating a configuration of ferrule 120. FIG. 4 is a perspective view of ferrule 120. FIG. 5A is a plan view of ferrule 120, FIG. 5B is a front view, and FIG. 5C is a back view. FIG. 6A is a sectional view taken along line A-A of FIG. 5A, and FIG. 6B is a sectional view taken along line B-B of FIG. 5A.

As illustrated in FIGS. 4, 5A to 5C, 6A and 6B, ferrule 120 is a member with a substantially cuboid shape. Ferrule 120 includes optical transmission member alignment part 121, opening 121a, first surface 122, second surface 123, and optical transmission member insertion part 124. In the present embodiment, ferrule 120 further includes supporting part 125. Note that ferrule 120 may not include supporting part 125.

Ferrule 120 is fixed to one end portion of the plurality of optical transmission members 110. Ferrule 120 is formed using a material that is optically transparent to light with wavelengths used for optical communications. Examples of the material of ferrule 120 include polyetherimide (PEI) such as ULTEM (registered trademark) and transparent resin such as cyclic olefin resin. In addition, ferrule 120 is manufactured by injection molding, for example.

Optical transmission member alignment part 121 aligns the plurality of optical transmission members 110 in one line in second direction D2 orthogonal to first direction D1. The configuration of optical transmission member alignment part 121 is not limited as long as the above-mentioned function can be ensured. In the present embodiment, optical transmission member alignment part 121 is the bottom surface of aligning recess 126 having opening 121a at the top surface of ferrule 120. Note that opening 121a may open at a side surface of ferrule 120. Inclined surface 126a is disposed at opening 121a of aligning recess 126. Inclined surface 126a is tilted toward bottom surface 126b of aligning recess 126 in the direction toward the center of aligning recess 126. In this manner, lid 130 can be appropriately guided to aligning recess 126. In the present embodiment, bottom surface 126b of aligning recess 126 is a flat surface.

First surface 122 is disposed to face the end surfaces of the plurality of optical transmission members 110 aligned by optical transmission member alignment part 121. First surface 122 allows incidence of light emitted from the plurality of optical transmission members 110 such that the light travels toward second surface 123, or emits, toward the end surfaces of the plurality of optical transmission members 110, light entered from second surface 123 and advanced inside ferrule 120. In the present embodiment, first surface 122 includes a plurality of first optical surfaces 122a. The shape of the plurality of first optical surfaces 122a is not limited as long as the above-mentioned function can be ensured. The plurality of first optical surfaces 122a may be a convex surface, or a flat surface. In the present embodiment, first optical surface 122a is a flat surface. First surface 122 (the plurality of first optical surfaces 122a) is disposed in a part of the inner surface of aligning recess 126. First optical surface 122a may be tilted to come closer to second surface 123 with decreasing distance to the top surface of ferrule 120, or may be perpendicular to the rear surface of ferrule 120. In the present embodiment, first surface 122 is tilted to come closer to second surface 123 with decreasing distance to the top surface of ferrule 120.

First installation surface 122b where first optical surface 122a is disposed may be tilted to come closer to second surface 123 with decreasing distance to the top surface of ferrule 120, or may be perpendicular to the rear surface of ferrule 120. In the present embodiment, first installation surface 122b is tilted to come closer to second surface 123 with decreasing distance to the top surface of ferrule 120. Preferably, the inclination angle of first installation surface 122b is the same as the inclination angle of the end surface of optical transmission member 110.

Specifically, in the present embodiment, the plurality of first optical surfaces 122a and first installation surface 122b are configured to be flush with each other. When third direction D3 is set to 0°, the inclination angle of the plurality of first optical surfaces 122a and first installation surface 122b is within a range of 3 to 8°, and is preferably within a range of 5 to 8°, for example. In the present embodiment, the inclination angle of the plurality of first optical surfaces 122a and first installation surface 122b is 8° when third direction D3 is set to 0°.

In addition, preferably, the end surfaces of the plurality of optical transmission members 110 are separated from the plurality of first optical surfaces 122a. If the end surface of optical transmission member 110 and the plurality of first optical surfaces 122a make contact with each other, the end surface of optical transmission member 110 or the plurality of first optical surfaces 122a may possibly be damaged when adjusting the position of the end surface of optical transmission member 110.

Second surface 123 is disposed at the front surface of ferrule 120. Second surface 123 emits, toward another optical connector, light entered from first surface 122, or allows incidence of light from another optical connector such that the light travels toward first surface 122. In the present embodiment, second surface 123 includes a plurality of second optical surfaces 123a. The shape of the plurality of second optical surfaces 123a is not limited as long as the above-mentioned function can be ensured. The plurality of second optical surfaces 123a may be convex surfaces, or flat surfaces. In the present embodiment, the plurality of second optical surfaces 123a are convex surfaces. The plan shape of the plurality of second optical surfaces 123a in plan view is not limited. The plan shape of second optical surface 123a may be a circular shape or a rectangular shape. In the present embodiment, the plan shape of the plurality of second optical surfaces 123a is a circular shape. In addition, the number of second optical surfaces 123a is the same as the number of optical transmission members 110. That is, in the present embodiment, the number of second optical surfaces 123a is 16.

Optical transmission member insertion part 124 is disposed on the side opposite to first surface 122 with respect to optical transmission member alignment part 121. Optical transmission member insertion part 124 includes first contact portion 124a where the plurality of optical transmission members 110 is touchable. In the present embodiment, optical transmission member insertion part 124 includes first contact portion 124a and second contact portion 124b.

When opening 121a side is set as the plus side and the opposite side as the minus side with respect to optical transmission member alignment part 121 in third direction D3 orthogonal to first direction D1 and second direction D2, first contact portion 124a is disposed to come closer to the minus side with increasing distance from first surface 122. First contact portion 124a can support the plurality of optical transmission members 110 in the state where it is tilted to come closer to the opening of aligning recess 126 in the direction from aligning recess 126 toward first surface 122. The configuration of first contact portion 124a is not limited as long as the above-described function can be ensured. First contact portion 124a may include an inclined surface that comes closer to the rear surface of ferrule 120 with increasing distance from optical transmission member alignment part 121, or corner portions of a plurality of step surfaces with a step form that comes closer to the rear surface of ferrule 120 with increasing distance from optical transmission member alignment part 121. Specifically, the end portion of first contact portion 124a on the back side of ferrule 120 is disposed on the rear surface side of ferrule 120 than optical transmission member alignment part 121 (bottom surface 126b of aligning recess 126). In the present embodiment, first contact portion 124a is an inclined surface that comes closer to the rear surface of ferrule 120 with increasing distance from optical transmission member alignment part 121. The inclination angle of first contact portion 124a with respect to a virtual line extending along first direction D1 in the cross section including first direction D1 and third direction D3 is not limited as long as the above-mentioned function can be ensured. The inclination angle is set as necessary. The inclination angle is within a range of 3 to 45°, for example.

Second contact portion 124b is disposed on optical transmission member alignment part 121 (aligning recess 126) side than first contact portion 124a. In the state where optical connector 100 is assembled, first portion 111 of optical transmission member 110 makes contact with second contact portion 124b. Second contact portion 124b is a flat surface extending along first direction D1 and disposed continuously to first contact portion 124a. Adhesive groove 127 is disposed between second contact portion 124b and aligning recess 126.

Adhesive groove 127 prevents the adhesive provided at optical transmission member alignment part 121 from flowing into optical transmission member insertion part 124. Adhesive groove 127 is disposed along second direction D2. One, or a plurality of adhesive grooves 127 may be provided. In the present embodiment, one adhesive groove 127 is provided.

Supporting part 125 is disposed to face first contact portion 124a in third direction D3. Supporting part 125 supports the plurality of optical transmission members 110 from the side opposite to optical transmission member insertion part 124. Supporting part 125 can support the plurality of optical transmission members 110 in the state where the plurality of optical transmission members 110 is tilted to come closer to the opening of aligning recess 126 in the direction from optical transmission member insertion part 124 toward first surface 122, and can also support the plurality of optical transmission members 110 along third direction D3. The configuration of supporting part 125 is not limited as long as the above-mentioned function can be ensured. In the present embodiment, supporting part 125 is disposed along second direction D2 on the side opposite to optical transmission member insertion part 124 with respect to optical transmission member 110 in the state where optical transmission member 110 is aligned by optical transmission member alignment part 121.

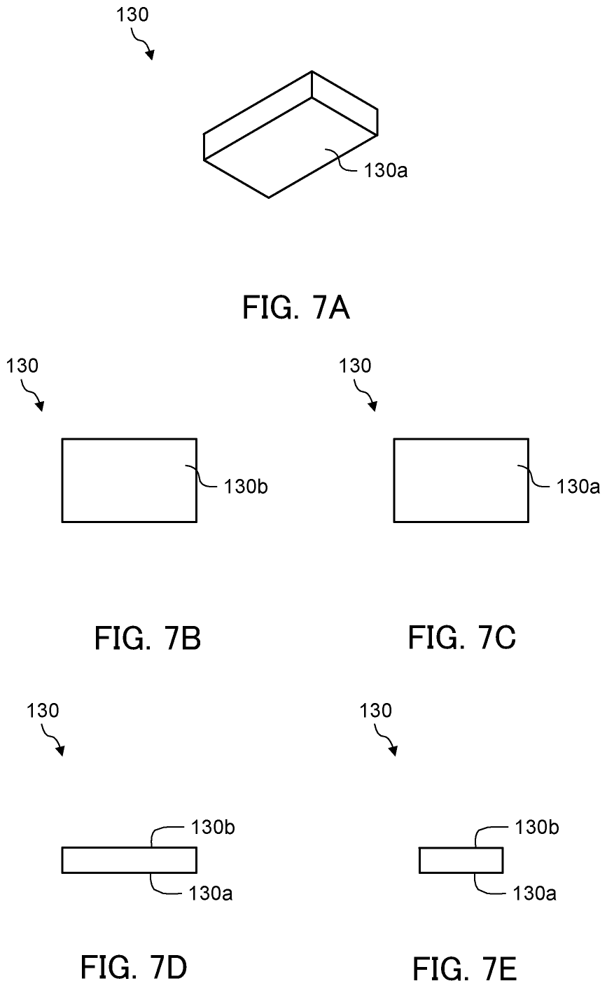

FIG. 7A is a perspective view of lid 130 as viewed from a lower side, FIG. 7B is a plan view, FIG. 7C is a bottom view, FIG. 7D is a front view, and FIG. 7E is a right side view.

Lid 130 presses the plurality of optical transmission members 110 to adjust the height of the end surfaces of the plurality of optical transmission members 110. At least a part of lid 130 is housed in aligning recess 126. The shape of lid 130 is not limited as long as the above-mentioned function can be ensured. As illustrated in FIGS. 7A to 7E, in the present embodiment, the shape of lid 130 is a cuboid shape. Lid 130 of the present embodiment is configured to be housed in aligning recess 126 in its entirety. Lid 130 includes pressing surface 130a for pressing the plurality of optical transmission members 110, and pressed surface 130b disposed on the side opposite to pressing surface 130a and configured to be pressed by an external device. Lid 130 has a cuboid shape, and thus pressing surface 130a and pressed surface 130b are parallel to each other.

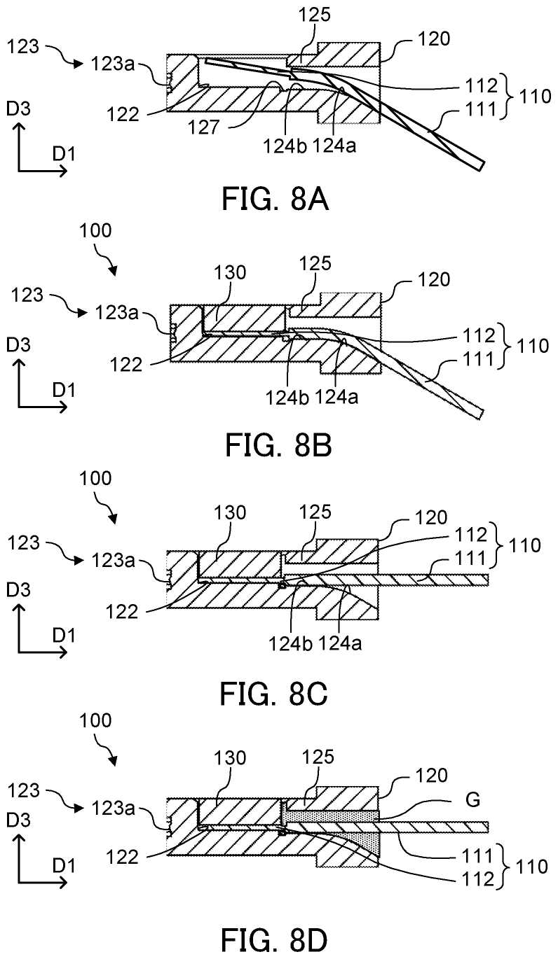

In aligning recess 126, adhesive G (see FIG. 8) fixes optical transmission member 110 in the state where the end surface of optical transmission member 110 faces first surface 122. Adhesive G may be thermosetting resin, or ultraviolet curable resin. In the present embodiment, adhesive G is optically transparent ultraviolet curable resin. Note that in this specification, adhesive G means a pre-cured state and a post-cured state.

### Manufacturing Method for Optical Connector

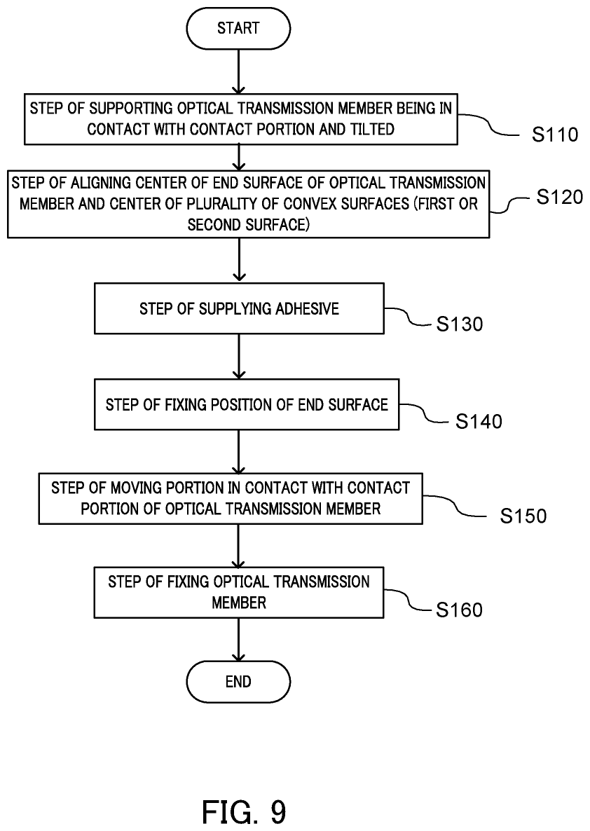

Here, a manufacturing method for optical connector 100 is described. FIGS. 8A to 8D are diagrams for describing a manufacturing method for optical connector 100. FIG. 9 is a flowchart illustrating a manufacturing method for optical connector 100.

Optical connector 100 can be manufactured through the following method, for example. As illustrated in FIGS. 8A to 8D and 9, the manufacturing method for optical connector 100 includes a step of supporting optical transmission member 110 in the state where it is in contact with contact portion 124a and tilted (S110) (hereinafter referred to as supporting step), a step of aligning the center of the end surface of optical transmission member 110 and a center of a plurality of convex surfaces (first optical surface 122a or second optical surface 123a) (S120) (hereinafter referred to as aligning step), a step of supplying adhesive G (S130), and fixing the position of the end surface (S140). Note that in addition to the above-mentioned steps, the present embodiment further includes a step of moving a portion in contact with contact portion 124a of optical transmission member 110 (S150) (hereinafter referred to as moving step), and a step of fixing optical transmission member 110 (S160).

First, the plurality of optical transmission members 110 is inserted from the back side opening of optical transmission member insertion part 124. At this time, second portion 112 is disposed at optical transmission member alignment part 121, and first portion 111 is disposed at optical transmission member insertion part 124.

As illustrated in FIG. 8A, at the supporting step (S110), the plurality of optical transmission members 110 is supported from the lower side with optical transmission member insertion part 124, and the plurality of optical transmission members 110 is supported from the upper side with supporting part 125. More specifically, in the state where the plurality of optical transmission members 110 is in contact with first contact portion 124a of optical transmission member insertion part 124, it is tilted to come closer to the opening of aligning recess 126 in the direction from aligning recess 126 toward first surface 122. That is, it is disposed in the order of first portion 111 and second portion 112 of optical transmission member 110 in the direction from optical transmission member insertion part 124 toward supporting part 125 in third direction D3, and it is disposed in the order of first portion 111 and second portion 112 of optical transmission member 110 in first direction D1 in the direction from optical transmission member insertion part 124 toward optical transmission member insertion part 124. At this time, first portion 111 is disposed in aligning recess 126, and second portion 112 is brought into contact with optical transmission member insertion part 124 and supporting part 125. In addition, preferably, optical transmission member insertion part 124 and supporting part 125 support the plurality of optical transmission members 110 such that the end portion of the plurality of optical transmission members 110 does not come out from the opening of aligning recess 126.

As illustrated in FIG. 8B, in the aligning step (S120), the end surface of optical transmission member 110 and first surface 122 (second surface 123) are set to face each other. More specifically, first surface 122 and the end surfaces of the plurality of optical transmission members 110 are aligned by pressing lid 130 toward the end portion of the plurality of optical transmission members 110 while monitoring whether light emitted from the end surfaces of the plurality of optical transmission members 110 is appropriately incident on the plurality of first surfaces 122, or whether light emitted from the plurality of first surfaces 122 is appropriately incident on the end surfaces of the plurality of optical transmission members 110. For example, adjustment is performed while confirming the result of the monitoring so that the end surface of optical transmission member 110 appropriately faces first surface 122 in such a manner that an external device presses pressed surface 130b of lid 130 and that pressing surface 130a presses optical transmission member 110. At this time, since the plurality of optical transmission members 110 is disposed in a tilted state, the entirety of the plurality of optical transmission members 110 makes contact with pressing surface 130a when pressed by lid 130. In this manner, the end surfaces of the plurality of optical transmission members 110 can be arranged in a line in second direction D2, and thus the end surface of optical transmission member 110 and first surface 122 can be appropriately set to face each other.

At the supplying step (S130), adhesive G is supplied to aligning recess 126. Preferably, at this time, adhesive G is supplied to cover the entire bottom surface 126b of aligning recess 126.

The step of fixing the position of the end surface (S140), the position of the aligned end surfaces of the plurality of optical transmission members 110 is fixed by curing adhesive G. In the present embodiment, adhesive G is cured by applying an ultraviolet ray in the state where the end surface of optical transmission member 110 and first surface 122 face each other.

As illustrated in FIG. 8C, at the moving step (S150), second portion 112 of optical transmission member 110 is moved from first contact portion 124a side toward supporting part 125 side such that first portion 111 and second portion 112 of optical transmission member 110 are at located on the same straight line. Here, the state on the same line includes the state on completely the same line and the state on substantially the same line.

As illustrated in FIG. 8D, at the step of fixing optical transmission member 110 (S160), second portion 112 of the plurality of optical transmission members 110 is fixed to ferrule 120. The method of fixing second portion 112 of optical transmission member 110 to ferrule 120 is not limited. It may be fixed by supplying the above-described adhesive G to the void, or a boot with a shape substantially complementary to the void may be disposed in the void. In the present embodiment, second portion 112 of optical transmission member 110 is fixed to ferrule 120 with adhesive G.

Through the above-described steps, optical connector 100 can be assembled by fixing optical transmission member 110 to ferrule 120.

Note that in the present embodiment, supporting part 125 is formed integrally with ferrule 120 as an example, but supporting part 125 may not be formed integrally with ferrule 120. In this case, supporting part 125 is disposed at lid 130. More specifically, supporting part 125 is pressing surface 130a of lid 130 and is a corner portion on optical transmission member insertion part 124 side. In this case, lid 130 is disposed in ferrule 120 such that the corner portion is the rotation center in second direction D2, so as to press optical transmission member 110 about the rotation center.

Note that in the present embodiment, the step of supporting optical transmission member 110 (S110), the step of aligning the end surface of optical transmission member 110 and first surface 122 (S120), and the step of supplying adhesive G (S130) are performed in this order, but this order is not limitative as long as optical connector 100 can be finally assembled. For example, the step of supplying adhesive G (S130) may be performed before the step of supporting optical transmission member 110 (S110), and the step of aligning the end surface of optical transmission member 110 and first surface 122 (S120) may be performed before the supplying step (S130).

### Effects

With optical connector 100 of the present embodiment, even in the case where the tip end of the plurality of optical transmission members 110 is bent, the height of the end surfaces of the plurality of optical transmission members 110 can be easily adjusted because it can perform uniform pressing in the state where the plurality of optical transmission members 110 is tilted.

### Embodiment 2

### Configuration of Optical Connector

Next, optical connector 200 according to Embodiment 2 is described. Optical connector 200 according to the present embodiment is different from optical connector 100 of Embodiment 1 only in the configuration of ferrule 220. The same components as those of Embodiment 1 are denoted with the same reference numerals, and the description thereof will be omitted. In view of this, in the following description, ferrule 220 is mainly described.

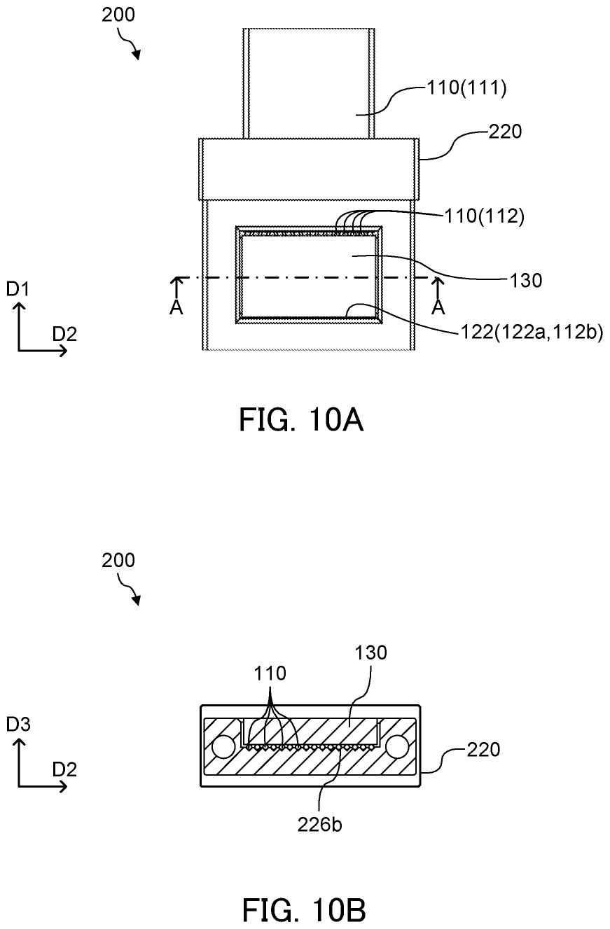

FIGS. 10A and 10B are diagrams illustrating a configuration of optical connector 200 according to Embodiment 2 of the present invention. FIG. 10A is a plan view of optical connector 200, and FIG. 10B is a sectional view taken along line A-A of FIG. 10A.

As illustrated in FIGS. 10A and 10B, optical connector 200 according to the present embodiment includes optical transmission member 110, ferrule 220, and lid 130. Optical connector 200 according to the present embodiment can be used as an optical connector module together with a housing, a spring clamp structure part and the like (omitted in the drawing). Optical transmission member 110 and lid 130 are the same as those of Embodiment 1, and therefore the description thereof will be omitted.

### Configuration of Ferrule

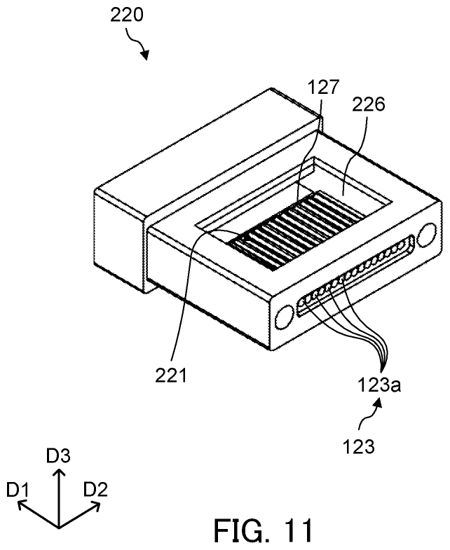

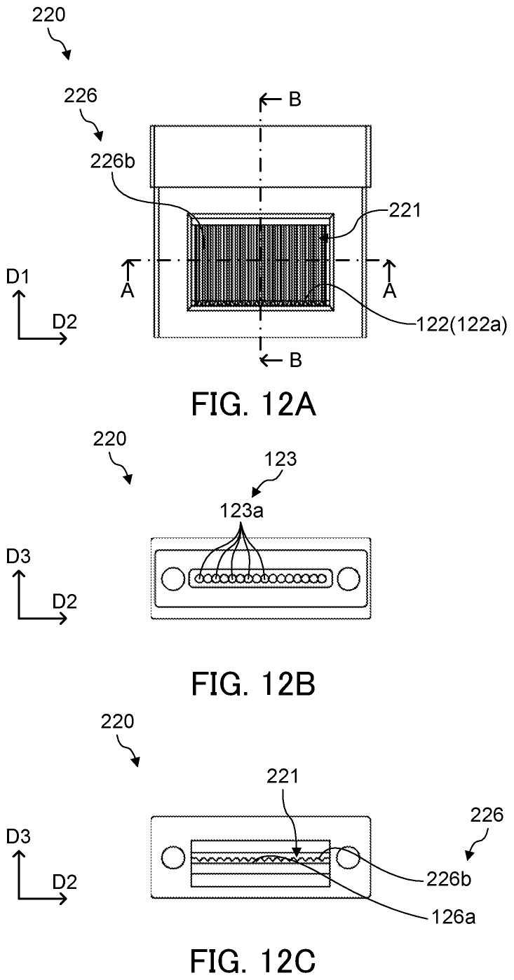

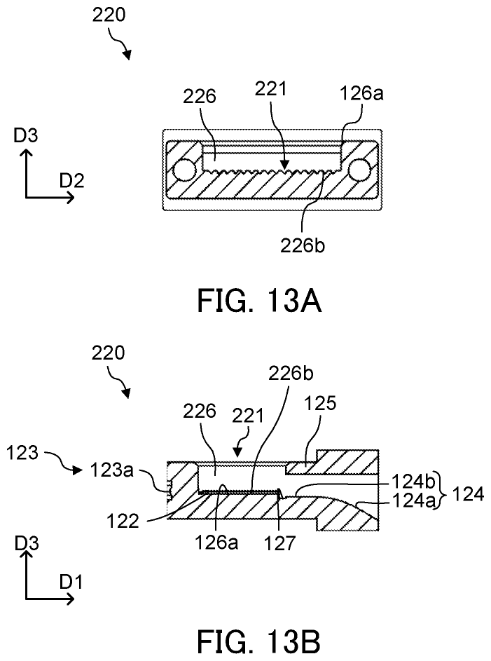

FIGS. 11, 12A to 12C, 13A and 13B are diagrams illustrating a configuration of ferrule 220 in the present embodiment. FIG. 11 is a perspective view of ferrule 220. FIG. 12A is a plan view of ferrule 220, FIG. 12B is a front view, and FIG. 12C is a back view. FIG. 13A is a sectional view taken along line A-A of FIG. 12A, and FIG. 13B is a sectional view taken along line B-B of FIG. 12A.

As illustrated in FIGS. 11, 12A to 12C, 13A and 13B, ferrule 220 includes optical transmission member alignment part 221, first surface 122, second surface 123, optical transmission member insertion part 124, and supporting part 125. First surface 122, second surface 123, optical transmission member insertion part 124, and supporting part 125 are the same as those of Embodiment 1, and therefore the description thereof will be omitted.

Optical transmission member alignment part 221 in the present embodiment is a space of aligning recess 226 opening at the top surface of ferrule 220. In aligning recess 226, a plurality of first grooves 226b is disposed in its bottom surface 126b. First groove 226b aligns the plurality of optical transmission members 110 in second direction D2. The plurality of first grooves 226b extends in first direction D1. The number of first groove 226b is not limited as long as the number is equal to or greater than the number of optical transmission members 110 installed. In the present embodiment, the number of first grooves 226b is 16. The cross-sectional shape of first groove 226b is not limited. First groove 226b may be a V-shaped groove, or a U-shaped groove. In the present embodiment, first groove 226b is a V-shaped groove. Preferably, the depth of first groove 226b is a depth with which in the state where optical transmission member 110 is disposed at first groove 226b, the upper end portion of optical transmission member 110 is located above the upper end portion of first groove 226b (ridge). First groove 226b may be disposed parallel to the rear surface of ferrule 120, or tilted with respect to the rear surface of ferrule 120. In the present embodiment, first groove 226b is disposed parallel to the rear surface of ferrule 120.

### Effects

Optical connector 200 of the present embodiment has an effect similar to that of optical connector 100 of Embodiment 1. In addition, with first groove 226b, optical connector 200 can appropriately install the plurality of optical transmission members 110 in second direction D2.

### Embodiment 3

### Configuration of Optical Connector

Next, optical connector 300 according to Embodiment 3 is described. Optical connector 300 according to the present embodiment is different from optical connector 100 of Embodiment 1 only in the configuration of lid 330. The same components as those of Embodiment 1 are denoted with the same reference numerals, and the description thereof will be omitted.

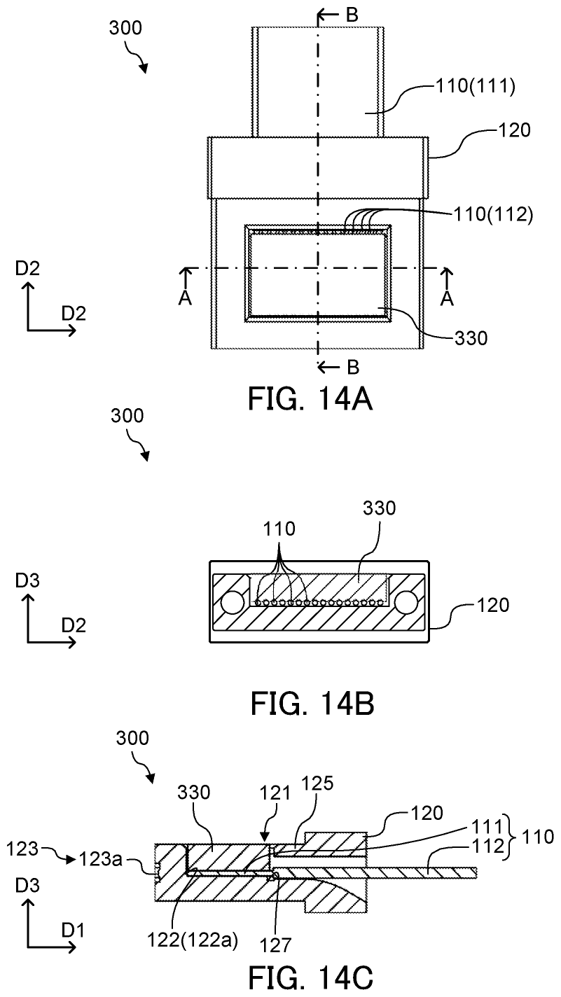

FIGS. 14A to 14C are diagrams illustrating a configuration of optical connector 300 according to Embodiment 3 of the present invention. FIG. 14A is a plan view of optical connector 300, FIG. 14B is a sectional view taken along line A-A of FIG. 14A, and FIG. 14C is a sectional view taken along line B-B of FIG. 14A.

As illustrated in FIGS. 14A to 14C, optical connector 300 according to the present embodiment includes optical transmission member 110, ferrule 120, and lid 330. Optical connector 200 according to the present embodiment can be used as an optical connector module together with a housing, a spring clamp structure part and the like (omitted in the drawing). Optical transmission member 110 and ferrule 120 are the same as those of Embodiment 1, and therefore the description thereof will be omitted.

### Configuration of Lid

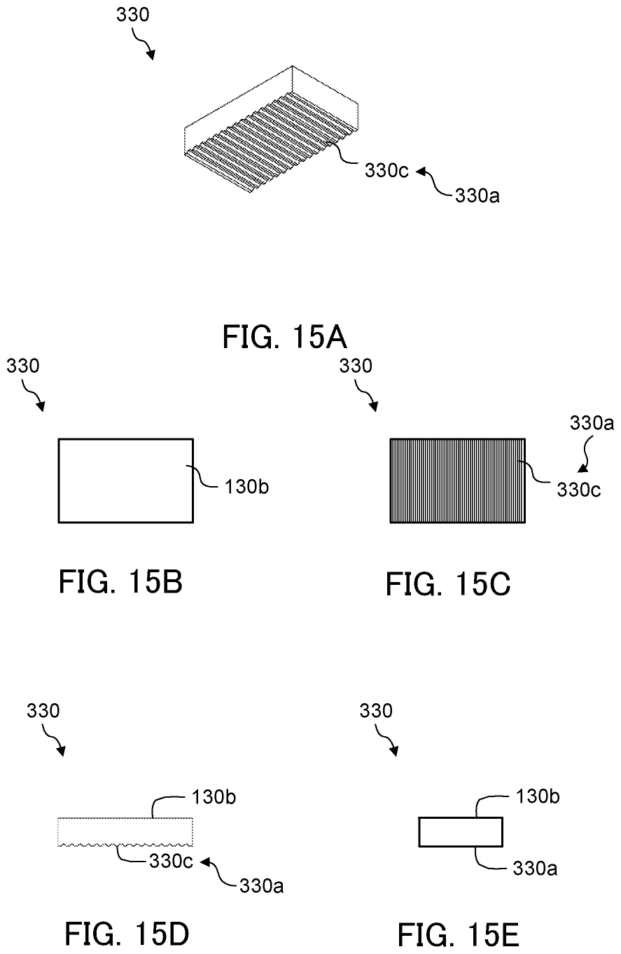

FIGS. 15A to 15E are diagrams illustrating a configuration of lid 330 in the present embodiment. FIG. 15A is a perspective view of lid 330 as viewed from a bottom surface side, FIG. 15B is a plan view of lid 330, FIG. 15C is a bottom view, FIG. 15D is a front view, and FIG. 15E is a right side view.

As illustrated in FIGS. 15A to 15E, lid 330 includes pressing surface 330a, pressed surface 130b, and a plurality of second grooves 330c. Second groove 330c aligns the plurality of optical transmission members 110 in second direction D2. The plurality of second grooves 330c extends in first direction D1 when housed in aligning recess 126. The number of second grooves 330c is not limited as long as the number is equal to or greater than the number of optical transmission members 110 to be pressed. In the present embodiment, the number of second groove 330c is 16. The cross-sectional shape of second groove 330c is not limited. Second groove 330c may be a V-shaped groove, or a U-shaped groove. In the present embodiment, second grooves 330c is a substantially V-shaped bottomed groove. Preferably, the depth of second groove 330c is a depth with which in the state where optical transmission member 110 is pressed at second groove 330c, the lower end portion of optical transmission member 110 is located below the upper end portion of second groove 330c (ridge).

### Effects

Optical connector 300 of the present embodiment has an effect similar to that of optical connector 100 of Embodiment 1. In addition, with second groove 330c, optical connector 300 can appropriately install the plurality of optical transmission members 110 in second direction D2.

### Embodiment 4

### Configuration of Optical Connector

Next, optical connector 400 according to Embodiment 4 is described. Optical connector 400 according to the present embodiment is different from optical connector 100 of Embodiment 1 in the configurations of ferrule 220 and lid 330. The same components as those of Embodiment 1 are denoted with the same reference numerals, and the description thereof will be omitted. In view of this, in the following description, ferrule 220 and lid 330 are mainly described.

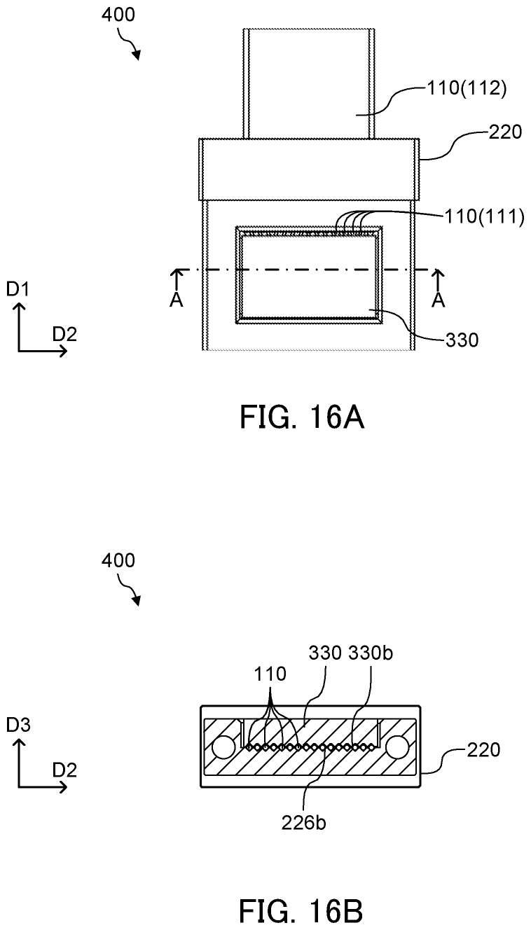

FIGS. 16A and 16B are diagrams illustrating a configuration of optical connector 400 according to Embodiment 3 of the present invention. FIG. 16A is a plan view of optical connector 400, and FIG. 16B is a sectional view taken along line A-A of FIG. 16A.

As illustrated in FIGS. 16A and 16B, optical connector 400 according to the present embodiment includes optical transmission member 110, ferrule 220, and lid 330. Optical connector 200 according to the present embodiment can be used as an optical connector module together with a housing, a spring clamp structure part and the like (omitted in the drawing). Ferrule 220 is the same as that of Embodiment 2, and lid 330 is the same as that of Embodiment 3.

### Effects

Optical connector 400 of the present embodiment has an effect similar to that of optical connector 100 of Embodiment 1. In addition, with first groove 226b and second groove 330c, optical connector 400 can appropriately install the plurality of optical transmission members 110 in second direction D2.

### Embodiment 5

### Configuration of Optical Connector

Next, optical connector 500 according to Embodiment 5 is described. Optical connector 500 according to the present embodiment is different from optical connector 100 of Embodiment 1 in the configurations of ferrule 520 and lid 530. The same components as those of Embodiment 1 are denoted with the same reference numerals, and the description thereof will be omitted.

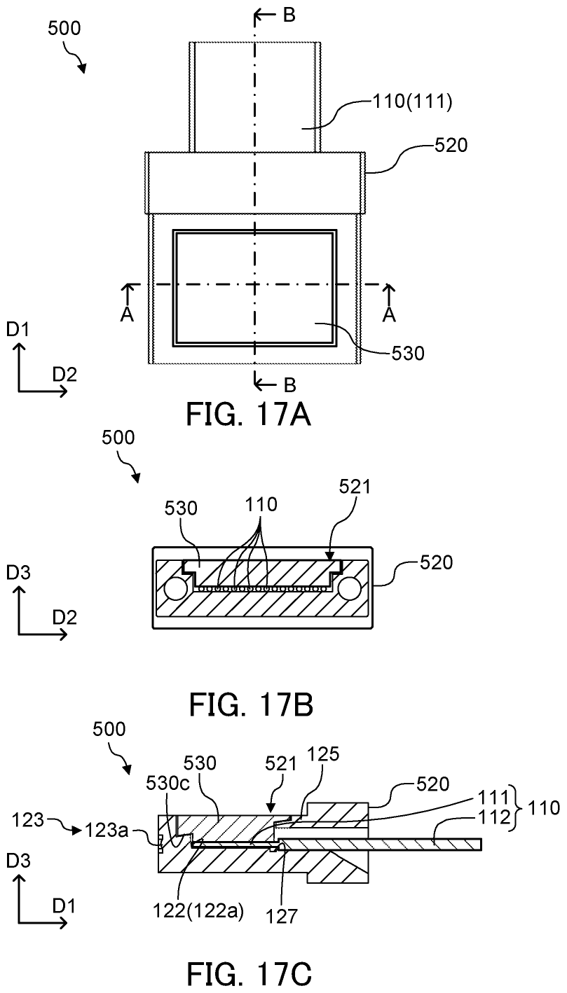

FIGS. 17A to 17C are diagrams illustrating a configuration of optical connector 500 according to Embodiment 3 of the present invention. FIG. 17A is a plan view of optical connector 300, and FIG. 17B is a sectional view taken along line A-A of FIG. 17A, and FIG. 17C is a sectional view taken along line A-A of FIG. 17A.

As illustrated in FIGS. 17A to 17C, optical connector 500 according to the present embodiment includes optical transmission member 110, ferrule 520, and lid 530. Optical connector 500 according to the present embodiment can be used as an optical connector module together with a housing, a spring clamp structure part and the like (omitted in the drawing).

### Configuration of Ferrule

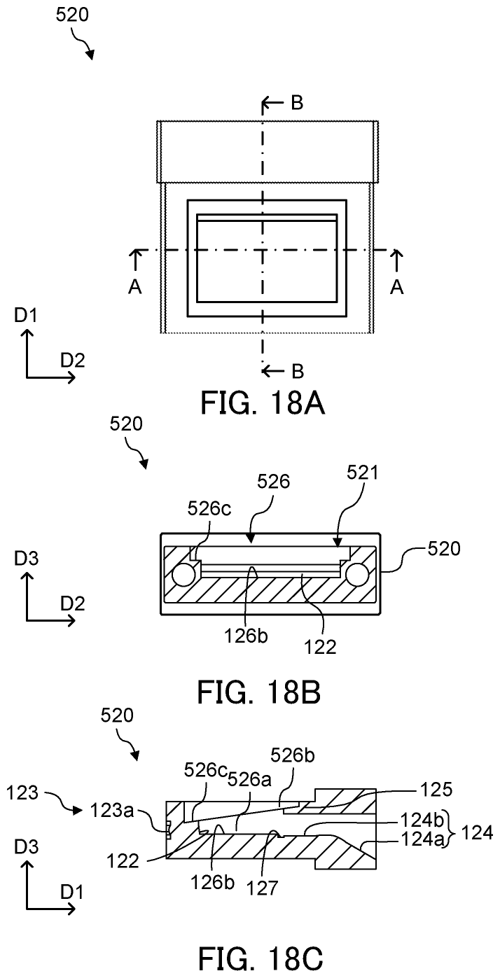

FIGS. 18A to 18C are diagrams illustrating a configuration of ferrule 520 according to Embodiment 5. FIG. 18A is a plan view of ferrule 520, FIG. 18B is a sectional view taken along line A-A of FIG. 18A, and FIG. 18C is a sectional view taken along line B-B of FIG. 18A.

As illustrated in FIGS. 18A to 18C, ferrule 520 includes optical transmission member alignment part 521, first surface 122, second surface 123, optical transmission member insertion part 124, and supporting part 125. First surface 122, second surface 123, optical transmission member insertion part 124, and supporting part 125 are the same as those of Embodiment 1, and therefore the description thereof will be omitted.

Optical transmission member alignment part 521 is a space of aligning recess 526 opening at the top surface of ferrule 220. Aligning recess 526 includes first recess 526a and second recess 526b.

First recess 526a is disposed on the rear surface side of ferrule 520. A part of lid 530 is housed in first recess 526a. First recess 526a opens at the bottom portion of second recess 526b.

Second recess 526b is disposed on the top surface side of ferrule 520. A part of lid 530 is housed in second recess 526b. First recess 526a opens at the bottom portion of second recess 526b. The bottom surface of second recess 526b is first contact surface 526c for supporting lid 530 by making contact with second contact surface 530c of lid 530.

First contact surface 526c is a flat surface inclined with respect to a straight line extending along first direction D1. In the present embodiment, first contact surface 526c is tilted to come closer to second surface 123 with decreasing distance to rear surface of ferrule 520. The inclination angle of first contact surface 526c is not limited. In the case of largely moving pressing surface 530a up and down, it suffices to increase the inclination angle of first contact surface 526c. In the case of slightly moving pressing surface 530a up and down, it suffices to decrease the inclination angle of first contact surface 526c. The inclination angle of first contact surface 526c is within a range of 0.1 to 10°. Note that in the present embodiment, the inclination angle of first contact surface 526c is 2°.

### Configuration of Lid

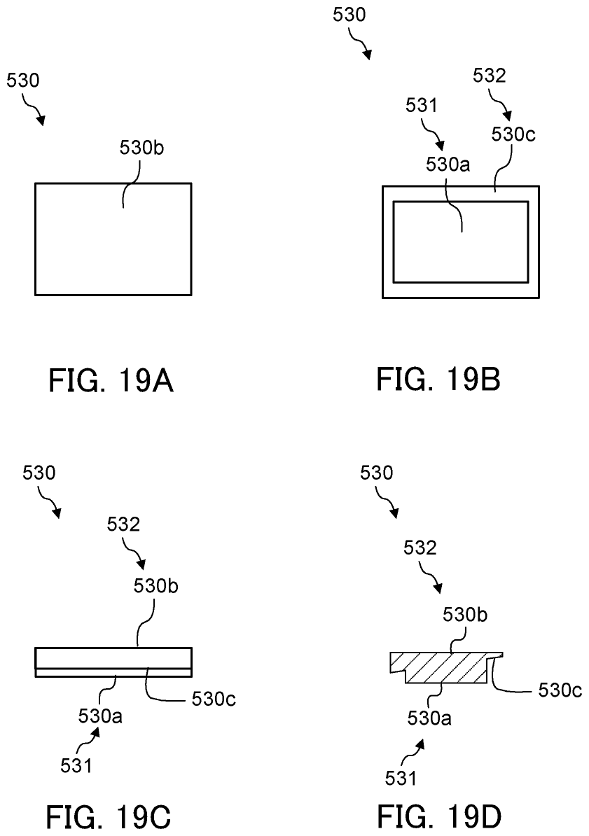

FIGS. 19A to 19D are diagrams illustrating a configuration of lid 530 in Embodiment 5. FIG. 19A is a plan view of lid 530, FIG. 19B is a bottom view, FIG. 19C is a front view, and FIG. 19D is a right side view.

As illustrated in FIGS. 19A to 19D, lid 530 presses the plurality of optical transmission members 110 to adjust the height of the end surfaces of the plurality of optical transmission members 110. At least a part of lid 530 is housed in recess 526. In the present embodiment, lid 530 includes first lid 531 and second lid 532. First lid 531 includes pressing surface 530a that presses optical transmission member 110. Second lid 532 includes pressed surface 530b to be pressed by an external device. The plan shape of second lid 530f is larger than first lid 530. The lower surface of second lid 530 is second contact surface 530c that makes contact with first contact surface 526c of optical transmission member alignment part 521.

Second contact surface 530c is a flat surface inclined with respect to pressing surface 530a. In the present embodiment, first contact surface 526c is tilted to come closer to second surface 123 with decreasing distance to the rear surface of ferrule 120 in the state where lid 530 is housed in optical transmission member alignment part 521. The inclination angle of second contact surface 530c is not limited. In the case of largely moving pressing surface 530a up and down, it suffices to increase the inclination angle of second contact surface 530c. In the case of slightly moving pressing surface 530a up and down, it suffices to decrease the inclination angle of second contact surface 530c. The inclination angle of second contact surface 530c with respect to pressing surface 530a is within a range of 0.1 to 10°. Note that in the present embodiment, the inclination angle is 2°, which is the same as the inclination angle of V first contact surface 526c.

Note that in the aligning step in the manufacturing method for optical connector 500 of the present embodiment, lid 530 is moved toward first surface 122 to align the end surfaces of the plurality of optical transmission members 110.

### Effects

Optical connector 500 of the present embodiment has an effect similar to that of optical connector 100 of Embodiment 1. In addition, with first contact surface 526c and second contact surface 530c, optical connector 500 can easily set optical transmission member 110 and first surface 122 to face each other.

### Embodiment 6

### Configuration of Optical Connector

Next, optical connector 600 according to Embodiment 6 is described. Optical connector 600 according to the present embodiment is different from optical connector 100 of Embodiment 1 in the configuration of ferrule 620. The same components as those of Embodiment 1 are denoted with the same reference numerals, and the description thereof will be omitted.

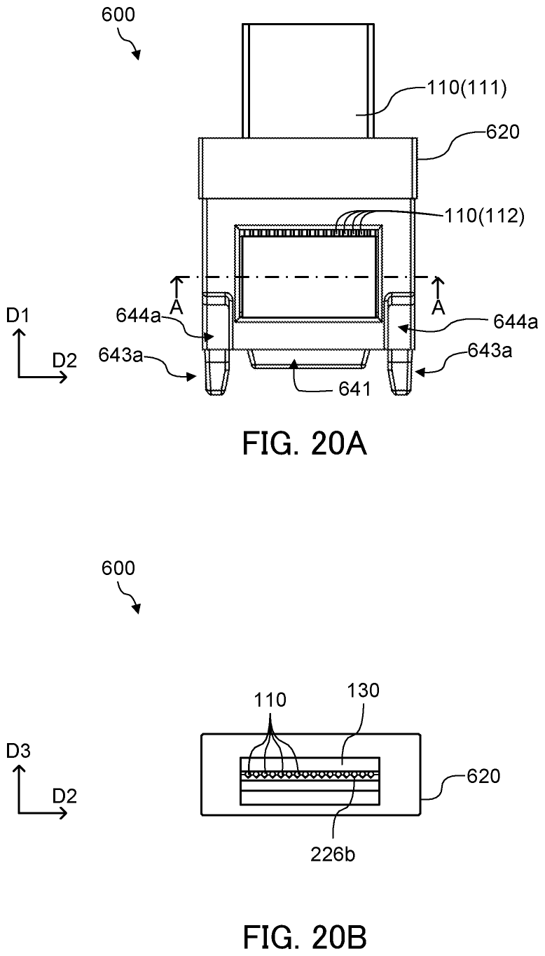

FIGS. 20A and 20B are diagrams illustrating a configuration of optical connector 600 according to Embodiment 6 of the present invention. FIG. 20A is a plan view of optical connector 600, and FIG. 20B is a sectional view taken along line A-A of FIG. 20A.

As illustrated in FIGS. 20A and 20B, optical connector 600 according to the present embodiment includes optical transmission member 110, ferrule 620, and lid 130. Two optical connectors 600 are paired (as a pair). The plurality of optical transmission members 110 are optically coupled with each other by connecting the same optical connectors 600 to one another in the state where one optical connector 600 holding the plurality of optical transmission members 110 is upside down with respect to another optical connector 600 holding the plurality of other optical transmission members 110. Optical transmission member 110 and lid 130 are the same as those of Embodiment 1, and therefore the description thereof will be omitted.

### Configuration of Ferrule

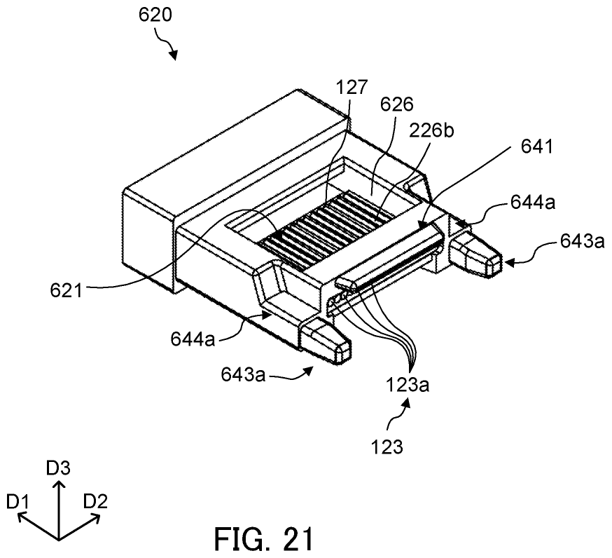

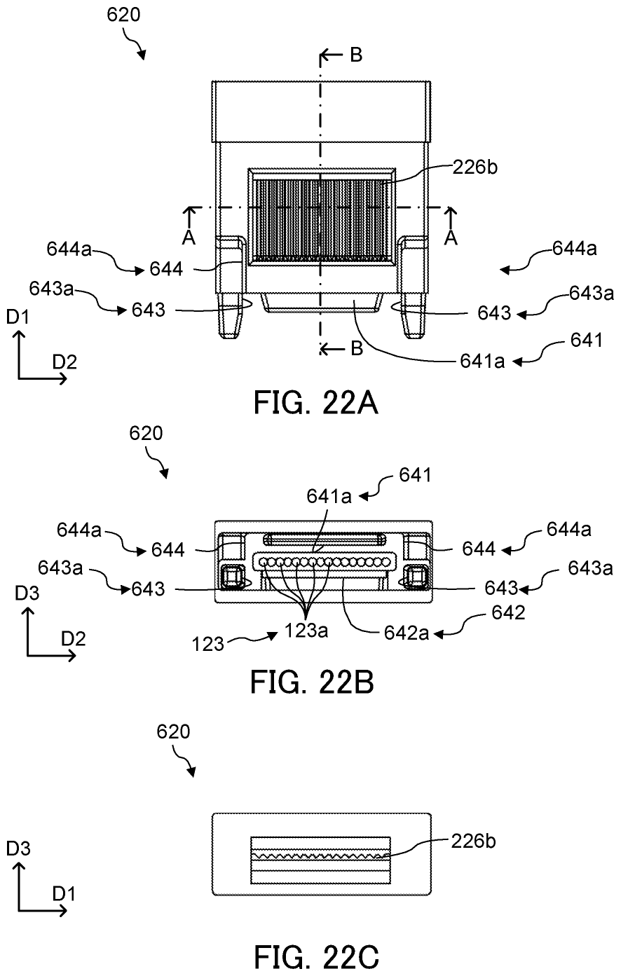

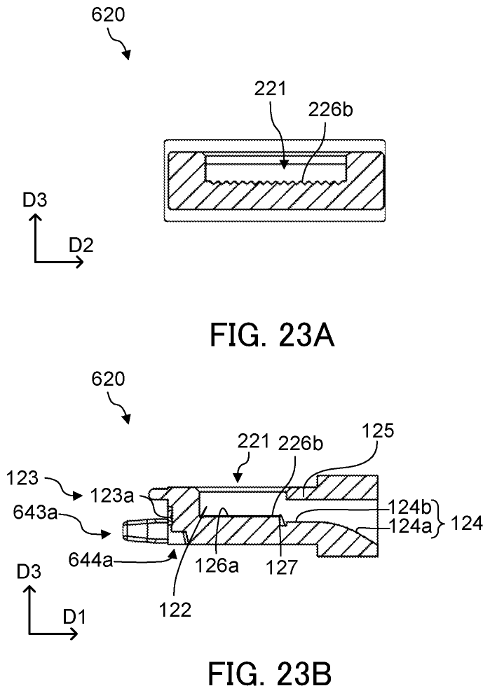

FIGS. 21, 22A to 22C, 23A and 23B are diagrams illustrating a configuration of ferrule 620 of Embodiment 6. FIG. 21 is a perspective view of ferrule 620 according to Embodiment 6. FIG. 22A is a plan view of ferrule 620, FIG. 22B is a front view, and FIG. 22C is a back view. FIG. 23A is a sectional view taken along line A-A of FIG. 22A, and FIG. 23B is a sectional view taken along line B-B of FIG. 22A.

As illustrated in FIGS. 21, 22A to 22C, 23A and 23B, ferrule 620 according to the present embodiment includes optical transmission member alignment part 221, first surface 122, second surface 123, optical transmission member insertion part 124, supporting part 125, protrusion 641 and recess 642, first inward restriction surface 643, and first outward restriction surface 644. Optical transmission member alignment part 221 is the same as that of Embodiment 2, first surface 122, second surface 123, optical transmission member insertion part 124, and supporting part 125 are the same as those of Embodiment 1, and therefore, the description thereof will be omitted.

In front view of second surface 123, protrusion 641 and recess 642 are disposed at positions where they are line-symmetric with respect to the reference straight line parallel to second direction D2. In the present embodiment, in front view of second surface 123, protrusion 641 and recess 642 are disposed with second optical surface 123a therebetween in third direction D3.

Protrusion 641 has a shape that can engage with recess 642 of another optical connector 600. In the present embodiment, protrusion 641 is disposed on the top side (upper side) at the front surface of optical connector 600. The shape of protrusion 641 is not limited as long as the positional displacement of optical connector 600 in third direction D3 can be suppressed. In the present embodiment, the shape of protrusion 641 is a ridge that is wide in second direction D2. Preferably, protrusion 641 includes second outward restriction surface 641a. Note that in the case where recess 642 includes second outward restriction surface 641a, it is preferable that protrusion 641 include second inward restriction surface 642a.

Second outward restriction surface 641a includes a flat surface disposed to face outward in third direction D3. With a flat surface, not a curved surface, second outward restriction surface 641a can suppress the positional displacement with respect to another optical connector 600 in third direction D3. One, or a plurality of second outward restriction surfaces 641a may be provided. In the present embodiment, one second outward restriction surface 641a is provided.

Recess 642 has a shape that can be engaged with protrusion 641 of another optical connector 600. In the present embodiment, recess 642 is disposed on the rear side (lower side) at the front surface of optical connector 600. The shape of recess 642 is not limited as long as the positional displacement of optical connector 600 in third direction D3 can be suppressed. In the present embodiment, recess 642 is a recess opening at the front surface and the bottom surface of optical connector 600. Preferably, recess 642 includes second inward restriction surface 642a. Note that in the case where protrusion 641 includes second inward restriction surface 642a, it is preferable that recess 642 include second outward restriction surface 641a.

Second inward restriction surface 642a includes a flat surface disposed to face inward in second direction D2 perpendicular to first direction D1 as viewed along a light path between optical connector 600 and another optical connector 600. With such a flat surface, not a curved surface, second inward restriction surface 642a can suppress the positional displacement in second direction D2 with respect to another optical connector 600. Second inward restriction surface 642a is disposed in contact with second outward restriction surface 641a of another optical connector 600.

First inward restriction surface 643 includes a flat surface disposed to face inward in second direction D2. In the present invention, with such a flat surface, not a curved surface, first inward restriction surface 643 can suppress the positional displacement in second direction D2 with respect to another optical connector 600. The number of first inward restriction surfaces 643 is not limited. In the present embodiment, (a pair of) two first inward restriction surfaces 643 are provided. In addition, in the present embodiment, first inward restriction surface 643 is a part of the outer surface of engaging protrusion 643a disposed with second surface 123 therebetween in second direction D2.

Engaging protrusion 643a are rectangular columns that are disposed at both end portions of optical connector 600 in second direction D2 on the rear surface side, and protruded from the front surface of optical connector 600. In the present embodiment, in plan view of second surface 123, the inner flat surface of engaging protrusion 643a is first inward restriction surface 643. In addition, in the present embodiment, in front view of optical connector 600, the pair of engaging protrusions 643a are disposed in a line-symmetric manner with respect to a virtual line passing through the center in the horizontal direction and extending in first direction D1.

First outward restriction surface 644 includes a flat surface disposed to face outward along second direction D2. With such a flat surface, not a curved surface, first outward restriction surface 644 can suppress the positional displacement in second direction D2 with respect to another optical connector 600. The number of first outward restriction surfaces 644 is not limited. In the present embodiment, (a pair of) two first outward restriction surfaces 644 are provided. In addition, in the present embodiment, first outward restriction surface 644 is a part of the inner surface of engaging recess 644a disposed with second surface 123 therebetween in second direction D2.

Engaging recesses 644a are recesses opening at corners on the top surface (upper surface) side at both end portions in second direction D2. In the present embodiment, the inner flat surface of engaging recess 644a is first outward restriction surface 644 in front view of second surface 123. In addition, in the present embodiment, a pair of engaging recesses 644a is disposed in a line-symmetric manner with respect to a virtual line passing through the center in the horizontal direction and extending along first direction D1 in front view of optical connector 600.

### Effects

Optical connector 600 of the present embodiment has an effect similar to that of optical connector 100 of Embodiment 1. In addition, optical connector 600 can be coupled with another optical connector 600 in an upside down manner, and thus the number of components can be reduced.

### INDUSTRIAL APPLICABILITY

The ferrule, the optical connector and the optical connector module according to the present invention are suitable for optical communications using optical transmission members.

### REFERENCE SIGNS LIST

100, 200, 300, 400, 500, 600 Optical connector
110 Optical transmission member
111 First portion
112 Second portion
120, 220, 520, 620 Ferrule
121, 221, 521 Optical transmission member alignment part
122 First surface
122a First optical surface
122b First installation surface
123 Second surface
123a Second optical surface
124 Optical transmission member insertion part
124a First contact portion
124b Second contact portion
125 Supporting part
126, 526 Aligning recess
126a Inclined surface
126b Bottom surface
127 Adhesive groove
130, 330, 530 Lid
130a, 530a Pressing surface
130b, 530b Pressed surface
226b First groove
330a Pressing surface
330c Second groove
526a First recess
526b Second recess
526c First contact surface
530c Second contact surface
531 First lid
532 Second lid
641 Protrusion
641a Second outward restriction surface
642 Recess
642a Second inward restriction surface
643 First inward restriction surface
643a Engaging protrusion
644 First outward restriction surface
644a Engaging recess
G Adhesive

What is claimed is:

1. A ferrule configured to hold a plurality of optical transmission members each extending in a first direction, the ferrule comprising:
an optical transmission member alignment part configured to align the plurality of optical transmission members in one line in a second direction orthogonal to the first direction;
an opening disposed to face the optical transmission member alignment part;
a first surface disposed to face end surfaces of the plurality of optical transmission members aligned by the optical transmission member part, the first surface being configured to allow incidence of light emitted from the plurality of optical transmission members or emit, to outside, light advanced inside the ferrule;
a second surface configured to emit, to the outside, light entered from the first surface or allow incidence of light from the outside; and
an optical transmission member insertion part disposed on a side opposite to the first surface with respect to the optical transmission member alignment part, and including a contact portion where the plurality of optical transmission members is touchable, wherein when an opening side is set as a plus side and a side opposite to the opening side is set as a minus side with respect to the optical transmission member alignment part set as a reference in a third direction orthogonal to the first direction and the second direction, a portion closest to the reference in the contact portion is disposed on the minus side, and a portion other than the portion closest to the reference in the contact portion is disposed to come closer to the minus side with increasing distance from the first surface.

2. The ferrule according to claim 1, further comprising a supporting part disposed to face the contact portion in the third direction and configured to support, from a side opposite to the contact portion, the plurality of optical transmission members inserted to the optical transmission member insertion part.

3. The ferrule according to claim 1, wherein the contact portion includes an inclined surface disposed to come closer to the minus side with increasing distance from the first surface, or corner portions of a plurality of step surfaces disposed to come closer to the minus side with increasing distance from the first surface.

4. The ferrule according to claim 1, wherein the first surface or the second surface includes a plurality of optical control surfaces, the number of the plurality of optical control surfaces being the same as the number of the plurality of optical transmission members.

5. An optical connector comprising:
a plurality of optical transmission members;
the ferrule according to claim 1 configured to hold the plurality of optical transmission members; and
a lid configured to adjust positions of the end surfaces of the plurality of optical transmission members with respect to the first surface by pressing the plurality of optical transmission members aligned by the optical transmission member alignment part and being in contact with the optical transmission member insertion part with a pressing surface configured to make contact with the plurality of optical transmission members.

6. The optical connector according to claim 5, wherein
the plurality of optical transmission members includes:
a first portion where the plurality of optical transmission members is coupled and aligned in one line; and
a second portion located on a tip end side than the first portion, the second portion being a portion where the plurality of optical transmission members is separated from each other.

7. A manufacturing method for the optical connector according to claim 5, the method comprising:
supporting the plurality of optical transmission members in a state where the plurality of optical transmission members is in contact with the contact portion and tilted;
aligning the end surfaces of the plurality of optical transmission members by pressing the lid toward the plurality of optical transmission members, or moving the lid toward the first surface such that light emitted from the end surfaces of the plurality of optical transmission members is incident on the first surface, or that light emitted from the first surface is incident on the end surfaces of the plurality of optical transmission members;
supplying an adhesive to the optical transmission member alignment part; and
fixing the positions of the end surfaces of the plurality of optical transmission members aligned, by curing the adhesive.

8. The method according to claim 5, further comprising:
supporting the plurality of optical transmission members in a state where the plurality of optical transmission members is in contact with the contact portion and tilted such that the plurality of optical transmission members comes closer to the plus side in a direction from the optical transmission member insertion part toward the optical transmission member alignment part by inserting the plurality of optical transmission members from a back side opening of the optical transmission member insertion part;
aligning the end surfaces of the plurality of optical transmission members by pressing the lid toward the plurality of optical transmission members or moving the lid toward the first surface such that light emitted from the end surfaces of the plurality of optical transmission members is incident on the first surface, or light emitted from the first surface is incident on the end surfaces of the plurality of optical transmission members;
supplying adhesive to the optical transmission member alignment part; and
fixing the positions of the end surfaces of the plurality of optical transmission members aligned, by curing the adhesive.

9. A manufacturing method for an optical connector including the ferrule according to claim 4, and a lid configured to adjust positions of the end surfaces of the plurality of optical transmission members with respect to the first surface by pressing the plurality of optical transmission members aligned by the optical transmission member alignment part and being in contact with the optical transmission member insertion part with a pressing surface configured to make contact with the plurality of optical transmission members, the method comprising:
supporting the plurality of optical transmission members in a state where the plurality of optical transmission members is in contact with the contact portion and separated from the optical transmission member alignment part such that the plurality of optical transmission members comes closer to the plus side in a direction from the optical transmission member insertion part toward the optical transmission member alignment part by inserting the plurality of optical transmission members from a back side opening of the optical transmission member insertion part;
aligning the end surfaces of the plurality of optical transmission members by pressing the lid toward the plurality of optical transmission members or moving the lid toward the first surface such that a center of the end surfaces of the plurality of optical transmission members and a center of the optical control surface coincide with each other;
supplying adhesive to the optical transmission member alignment part; and
fixing the positions of the end surfaces of the plurality of optical transmission members aligned, by curing the adhesive.

10. The method according to claim 7,
wherein the plurality of optical transmission members includes:
a first portion where the plurality of optical transmission members is coupled and aligned in one line; and
a second portion located on a tip end side than the first portion, the second portion being a portion where the plurality of optical transmission members is separated from each other; and
wherein in the supporting, the second portion is disposed at the optical transmission member alignment part, and the first portion is brought into contact with the contact portion.

11. The method according to claim 10, further comprising moving the second portion from a contact portion side toward a supporting part side after the fixing of the positions of the end surfaces of the plurality of optical transmission members.

12. An optical connector module comprising the optical connector according to claim 5.

13. The method according to claim 8,
wherein the plurality of optical transmission members includes:
a first portion where the plurality of optical transmission members is coupled aligned in one line; and
a second portion located on a tip end side than the first portion, the second portion being a portion where the plurality of optical transmission members is separated from each other; and
wherein in the supporting, the second portion is disposed at the optical transmission member alignment part, and the first portion is brought into contact with the contact portion.

14. The method according to claim 9,
wherein the plurality of optical transmission members includes:
a first portion where the plurality of optical transmission members is coupled aligned in one line; and
a second portion located on a tip end side than the first portion, the second portion being a portion where the plurality of optical transmission members is separated from each other; and
wherein in the supporting, the second portion is disposed at the optical transmission member alignment part, and the first portion is brought into contact with the contact portion.

15. An optical connector module comprising the optical connector according to claim 6.
